(19) United States
(12) Patent Application Publication
(10) Pub. No.: US 2004/0128684 A1
(43) Pub. Date: Jul. 1, 2004

(54) Television broadcast receiving apparatus and method thereof

(75) Inventor: Kazumi Suga, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/725,527

(22) Filed: Dec. 3, 2003

(30) Foreign Application Priority Data
Dec. 13, 2002 (JP) 2002-362703

(51) Int. Cl. G06F 3/00; H04N 5/445; G06F 13/00; H04N 7/16

(52) U.S. Cl. 725/39; 725/37; 725/153

(57) ABSTRACT

In a television broadcast receiving apparatus, program information data are received together with plural pieces of program data, and a print mode of the program information is, when printing the program data, determined so that the program information data are laid out just on a predetermined number of print page(s). With this contrivance, the program information sorted out in an easy-to-view form and thus printed, can be obtained.

### BACKGROUND OF THE INVENTION

1. Field of the Invention

The present invention relates generally to a television broadcast receiving technology, and more particularly to a television broadcast receiving technology of receiving encoded video signals, audio signals, program information signals, etc. as on CS digital broadcasting, BS digital broadcasting and ground wave digital broadcasting, making the video/audio signals displayable by decoding these encoded signals, and providing an electronic program table (which will hereinafter be abbreviated to EPG) to an operator.

2. Related Background Art

In the digital broadcasting that has started in recent years, program line-up information is multiplexed with voice information, etc. and thus broadcast so that a receiver side can create the EPG for facilitating a program selection. FIGS. 10A and 10B show names and functions of program line-up information tables written in a draft of [Program Line-up Information Utilized for Digital Broadcasting] issued by ARIB (Association of Radio Industries and Businesses). Further, FIG. 11 shows PIDs (Packet Identifiers) of the program line-up information tables. A name of an organized channel, a name of program, a broadcasting date/time and explanation of content can be obtained by referring to this program line-up information table. Each receiver can create the EPG by use of these pieces of information. FIGS. 2A and 2B shows a display example of the EPG. Specifications of this EPG are in principle a commercial product planning matter of a maker of the receiver but are not standardized.

There have been made a variety of proposals about displaying this EPG. For instance, Japanese Patent Application Laid-Open No. 61-227486 discloses a technology of displaying only program tables after the present time just when looking at the present time. Further, Japanese Patent Application Laid-Open No. 9-37167 discloses a method of changing a display line-up of the EPG in accordance with how an aspect ratio of the display apparatus is set. According to these proposals, the EPG is displayed on the display apparatus, however, for instance, Japanese Patent Application Laid-Open No. 11-275462 discloses a system for printing by a printing apparatus as well as displaying on the display apparatus. Moreover, Japanese Patent Application Laid-Open No. 2001-223968 discloses a printing apparatus for storing the EPG data in a table format after filtering the EPG data, and laying out and printing the EPG data based on a print control program of a printer apparatus.

[Patent Document 1]

Japanese Patent Application Laid-Open No. 61-227486

[Patent Document 2]

Japanese Patent Application Laid-Open No. 9-37167

[Patent Document 3]

Japanese Patent Application Laid-Open No. 11-275462

[Patent Document 4]

Japanese Patent Application Laid-Open No. 2001-223968

The examples of the prior arts described above are based on the premise that the EPG is displayed on a normal consumer television image receiver (horizontal and vertical resolutions are respectively 720 and 480 or 1920 and 1080) having a comparatively low resolution, and hence a quantity of information displayable at one time is small. To be more specific, for example, only program information for 5 channels for 3 hours can be displayed at one time, wherein a viewer has no alternative but to view the desired program information in a way that scrolls a screen by use of a remote controller, etc. Further, the problem is not solved even by printing the EPG on this screen. Besides, this problem becomes more conspicuous in the digital broadcasting of which multi-channels are characteristic. Moreover, it is easily presumed from the examples of the prior arts to print all pieces of audio-visually enjoyable EPG information, however, none of the examples of the prior arts of the EPG printing took an easy-to-view contrivance to the operator into consideration.

An object of the present invention is to provide a television broadcast receiving technology enabling an acquisition of all-hour program information of all the audio-visually enjoyable channels in an easy-to-view form to the viewer separately from the EPG displayed on the display apparatus.

### SUMMARY OF THE INVENTION

To accomplish the above object, a television broadcast receiving apparatus according to the present invention includes a receiving unit for receiving television broadcasting waves transmitted in a way that multiplexes program information data together with plural pieces of program data, and a print controller for converting the program information data received by the receiving unit into data for printing, and outputting program information to a printer, wherein the print controller determines a print mode of the program information so that the program information is laid out just on a predetermined number of page(s).

### BRIEF DESCRIPTION OF THE DRAWINGS

FIG. 1 is an explanatory block diagram of an example of a whole architecture in embodiments of the present invention;

FIGS. 2A and 2B are explanatory conceptual diagrams of an EPG image in an example of the prior art;

FIG. 3 is an explanatory conceptual diagram of a program guide information image in a first embodiment of the present invention;

FIG. 4 is an explanatory conceptual diagram of the program guide information image in a second embodiment of the present invention;

FIG. 5 is an explanatory conceptual diagram of the program guide information image in a third embodiment of the present invention;

FIG. 6 is an explanatory flowchart of a system control unit in the first embodiment of the present invention;

FIG. 7 is an explanatory flowchart of the system control unit in the second embodiment of the present invention;

FIG. 8 is an explanatory flowchart of the system control unit in the third embodiment of the present invention;

FIG. 9 is comprised of FIGS. 9A and 9B showing explanatory flowcharts of the system control unit in a fourth embodiment of the present invention;

FIG. 10 is comprised of FIGS. 10A and 10B showing explanatory diagrams of tables related to program line-up information in digital broadcasting; and

FIG. 11 is an explanatory diagram of the tables related to the program line-up information in the digital broadcasting.

### DESCRIPTION OF THE PREFERRED EMBODIMENTS

One characteristic of embodiments of the present invention lies in a contrivance of enabling an operator to print all items of program guide information in an easy-to-view form by use of a high-resolution printing unit so as to simply immediately obtain a necessary item of program guide information. In the case of utilizing the high-resolution printing unit, for example, a printing unit having a resolution on the order of 600 dpi, it is possible to acquire the number of (both horizontal and vertical) pixels that is approximately ten times the number of pixels by a normal NTSC (National Television System committee)-based TV image receiver even on a sheet of A4-sized paper. Accordingly, the great majority of program information can be listed up by a layout, wherein a time axis for 24 hours is taken on a vertical axis (short side) defined as one side of the sheet, and an audio-visually enjoyable program is taken on a horizontal axis (long side) defined as another side of the sheet.

According to a first embodiment (corresponding to second and third print modes) of the present invention, predetermined number of channels are printed in a predetermined font size on one sheet of paper, and a necessary number of sheets are printed, thus printing all the audio-visually enjoyable channels. According to the first embodiment of the present invention, there are two cases, i.e., a case in which the program guide information is printed separately for the morning (A.M.) and the afternoon (P.M.) and a case of being printed simultaneously on one page. Any cases are, as a matter of course, available, however, a larger font can be, needless to say, used in the A.M/P.M. separate printing mode. Further, a comparatively large font size is fixed for an easy-to-see print to senior persons, and the program guide information can be printed on plural pages of fixed-size sheets, corresponding to the number of channels.

According to a second embodiment (corresponding to a fourth print mode) of the present invention, roll paper is utilized as the printing paper, whereby the layout processing is omitted in a way that calculates the number of channels for one sheet in the first embodiment.

According to a third embodiment (corresponding to a first print mode) of the present invention, a contrivance is that a preferable font size is determined corresponding to the number of audio-visually enjoyable channels, and all the items of program information can be printed on one sheet. In this case, all the information, though the font size becomes small, can be laid out just on one sheet of fixed-size paper, and hence the time for acquiring the necessary item of information is shortened and the sheets are saved.

A fourth embodiment of the present invention enables the operator to select the printing methods in the first, second and third embodiments.

(First Embodiment)

The first embodiment of the present invention will hereinafter be discussed with reference to the drawings.

In the following explanation, the solid line represents a data line, and the broken line represents a control line.

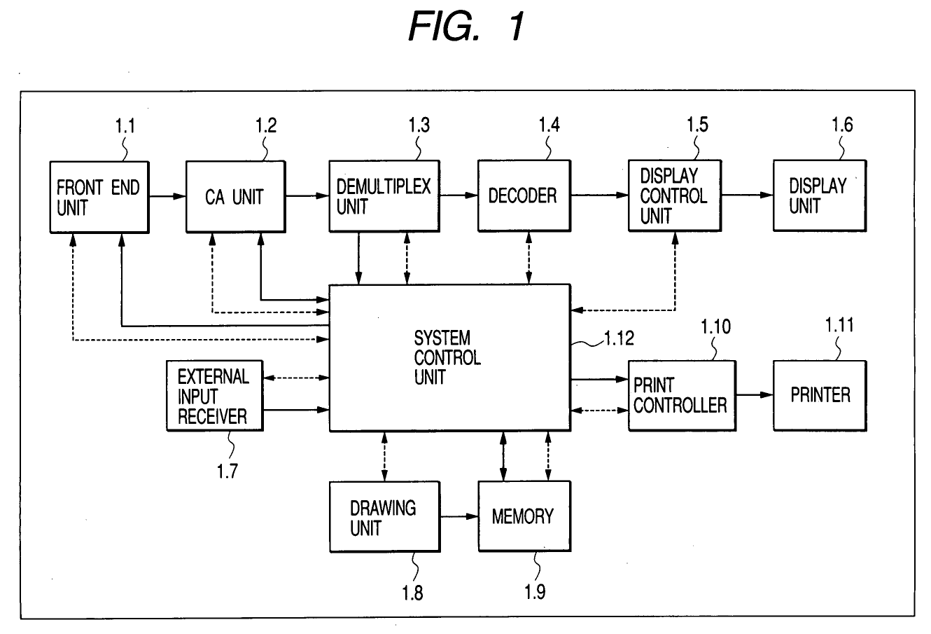

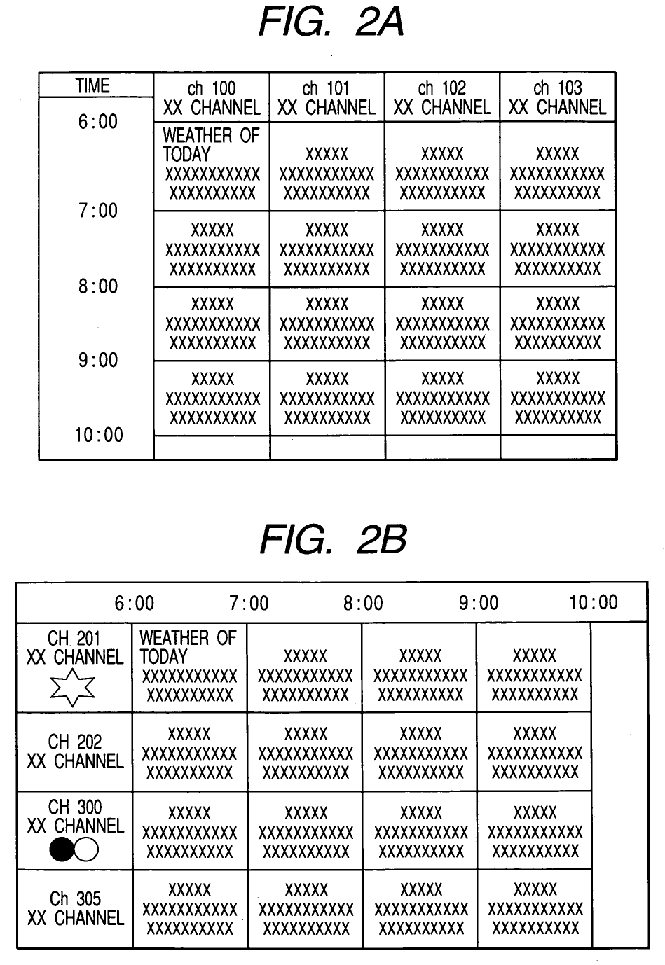

FIG. 1 is a block diagram showing an example of architecture of a television image receiver (a program information print control apparatus) in the first embodiment of the present invention.

This block is constructed of a front end units 1.1, a CA (conditional Access) unit 1.2, a demultiplex unit 1.3, a decoder 1.4, a display control unit 1.5, a display unit 1.6, an external input receiver 1.7, a drawing unit 1.8, a memory 1.9, a print controller 1.10, a printer 1.11 and a system control unit 1.12.

Transport streams demodulated by the front end unit 1.1 are, if scrambled (encrypted), descrambled by the CA unit 1.2 and thereafter demultiplexed into video/audio/information signals by the demultiplex unit 1.3. Among these categories of signals, the video signal is decoded by the decoder 1.4 and converted by the display control unit 1.5 into a signal displayable on the display unit 1.6. The system control unit 1.12, upon detecting a program guide print request give from an operator via the external input receiver 1.7, creates a program guide image (an EPG image for print) by use of the drawing unit 1.8 on the basis of the program information data obtained from the demultiplex unit 1.3 described above, and has the created image stored on the memory 1.9. The thus stored program guide image is sent to the print controller 1.10 at a desired timing, then converted into signals suited to the printer and printed by the printer 1.11. Note that audio signal is not related to the embodiments of the present invention, and hence its explanation is omitted.

<Front End Unit>

The front-end unit 1.1 is, in detail, constructed of a tuner unit, a demodulation unit and an error correction unit (unillustrated). The front-end unit 1.1 demodulates RF signals outputted from an antenna (not shown), and, after being, for example, 8PSK-demodulated, an error is detected and corrected as the necessity may arise.

<CA Unit>

The CA unit is, in detail, constructed of a CAM (Conditional Access Module) of an IC card, a card reader and a descrambler (not shown). The CAM is stored with a key together with a decryption program that is needed for decrypting a cryptogram and with accounting information, etc. In case signals encrypted (scrambled) on the side of a broadcasting station are sent, an encrypted work key is scrambled in broadcasting waves is decrypted by use of this intra-CAM master key, then the cryptogram of the scramble key is decrypted by using this work key, and descrambling of a TS (Transport Stream) payload is performed by use of this scramble key. Note that a judgement as to whether the encryption is done or not is made in a way that refers to a scramble control flag and adaptation field control stored in a TS packet header.

<Demultiplex Unit>

The demultiplex unit 1.3 demultiplexes the transport streams outputted from the CA unit 1.2 respectively into video/audio/information signals. Among these categories of signals, the video signal is outputted to the decoder 1.4, the audio signal is outputted to an audio output unit such as a speaker, etc. through an unillustrated D/A converter, and the information signal is outputted to the memory 1.9 via the system control unit 1.12.

<Decoder>

The decoder 1.4 decodes the video signal outputted from the demultiplex unit 1.3 and outputs the decoded signal to the display control unit 1.5.

<Display Control Unit>

Subsequently, the display control unit 1.5 will be explained. The display control unit 1.5 converts the signals outputted from the decoder 1.4 into data displayable on the display unit 1.6.

<Display Unit>

The display unit 1.6 may be a thin and lightweight type dot matrix display such as a liquid crystal display and a plasma display and may also be a normal CRT display.

<External Input Receiver>

The external input receiver 1.7 is a unit for receiving an operation of the operator using an operation key provided on a front surface of a remote controller or the TV receiver, and is controlled the system control unit 1.12 that will be described later on. The external input receiver 1.7 is used for the EPG print request, etc. given from the operator. In a case where the operation of the operator is performed by the normal remote controller, the external input receiver 1.7 performs a role as an IR (infrared-rays) receiving unit.

<Drawing Unit>

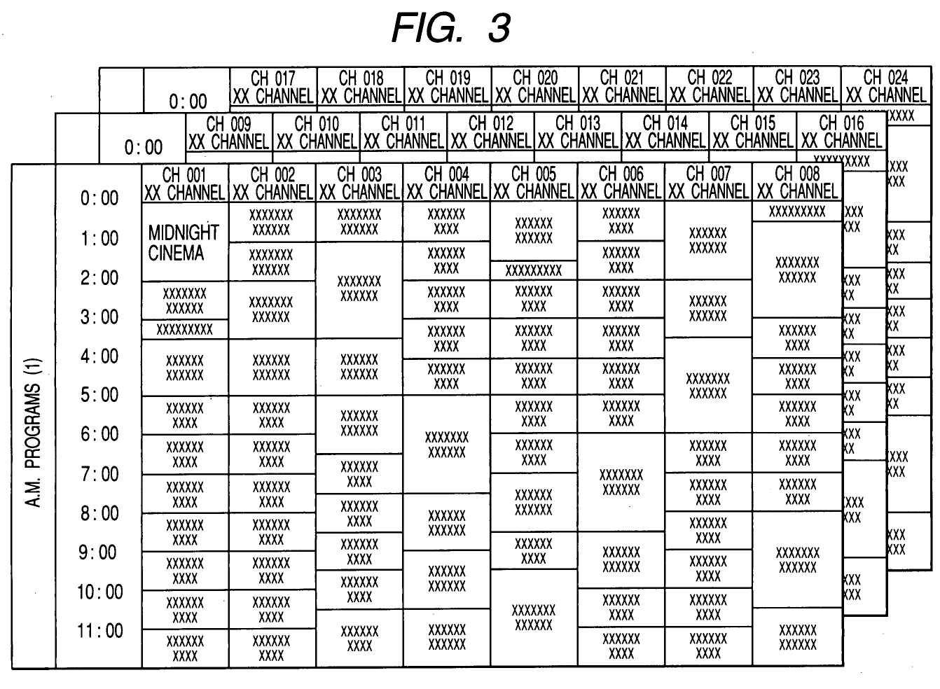

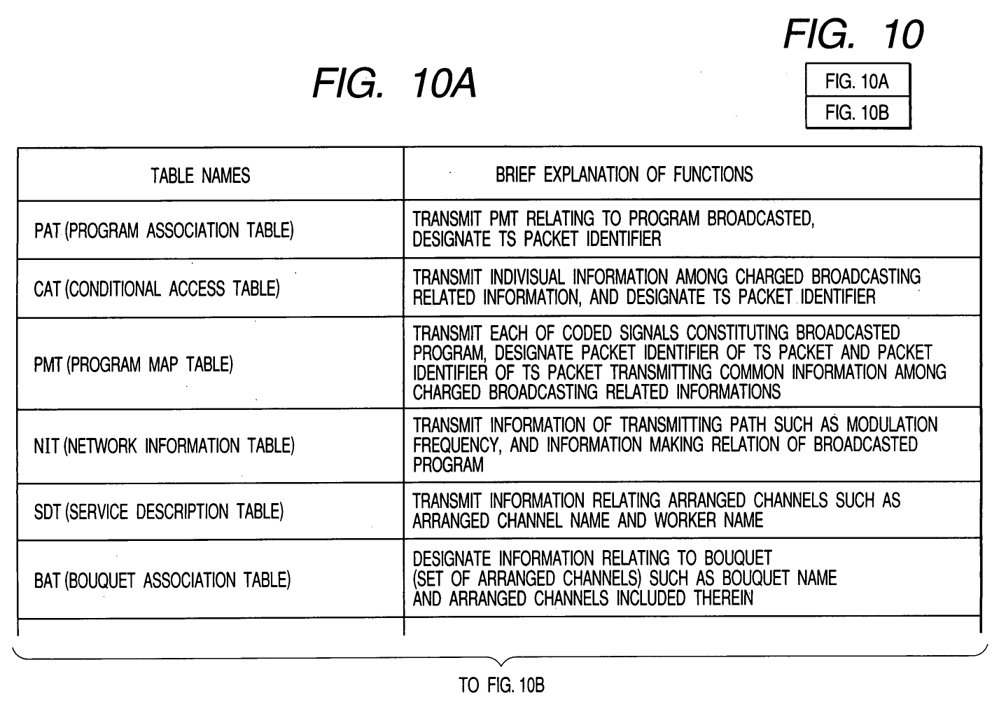

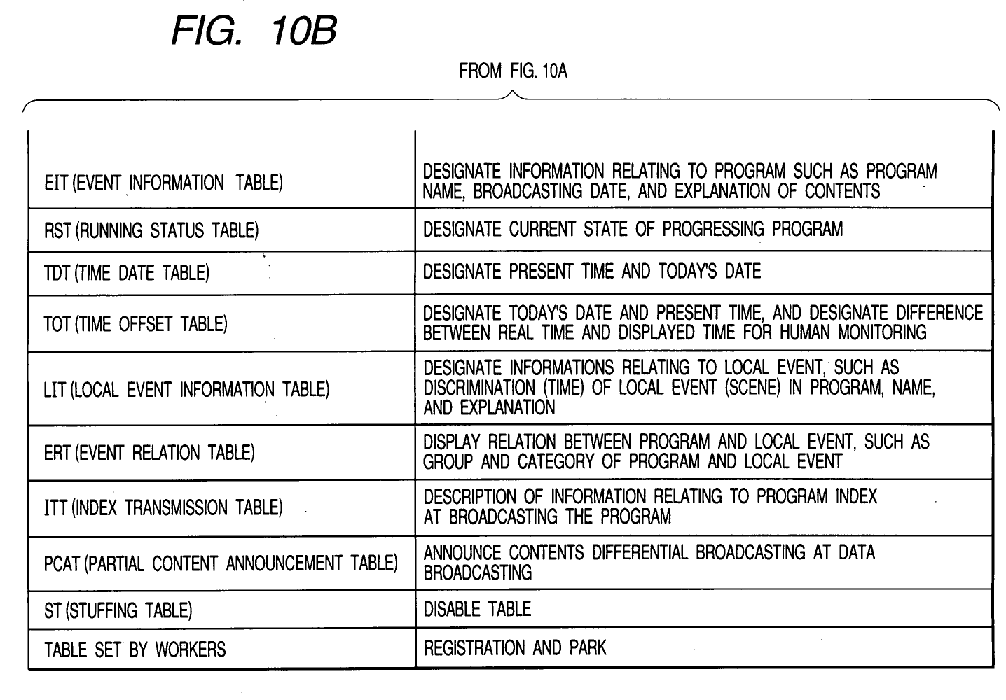

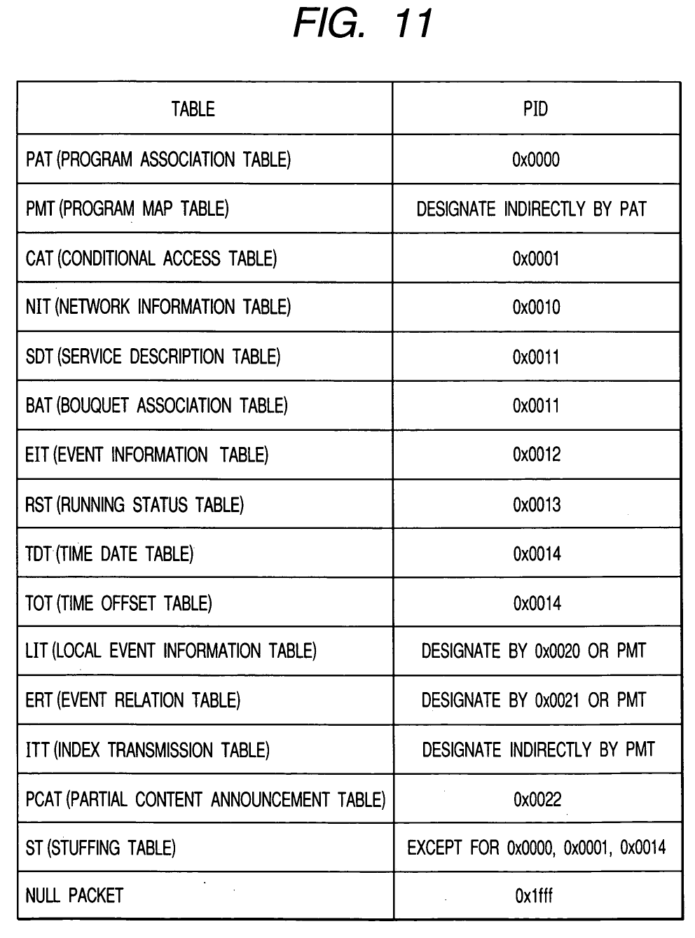

The drawing unit 1.8 undergoes control of the system control unit 1.12 that will hereinafter be explained, and creates a program guide image containing a description of the program information by use of the program information data (see FIGS. 10A and 10B) outputted from the demultiplex unit 1.3. FIG. 3 shows an example of the program guide image in the first embodiment of the present invention. FIG. 3 illustrates the example in which the program guide is divided into A.M. programs and P.M. programs, and the number of channels printed on one page is set to 8. As a matter of course, both of the A.M. programs and P.M. programs can be printed at one time.

<Memory>

The memory 1.9 is stored with the program guide image created by the drawing unit 1.8. The program guide image stored on the memory 1.9 is read at a preferable timing when printed by the printer 1.11 under the control of the system control unit 1.12.

<Print Controller>

The print controller 1.10 receives the program guide image stored on the memory 1.9 under the control of the system control unit 1.12 that will be explained later on, and converts this program guide image into signals suited to the printer 1.11 which will hereinafter be described.

<Printer>

The printer 1.11 receives the signals outputted from the print controller 1.10 and prints the program guide image. A premise in the first embodiment of the present invention is that the program guide image be printed on a fixed-size sheet such as A3-, A4- and B4-sized sheets. Cases of other embodiments will be described later on.

<System Control Unit>

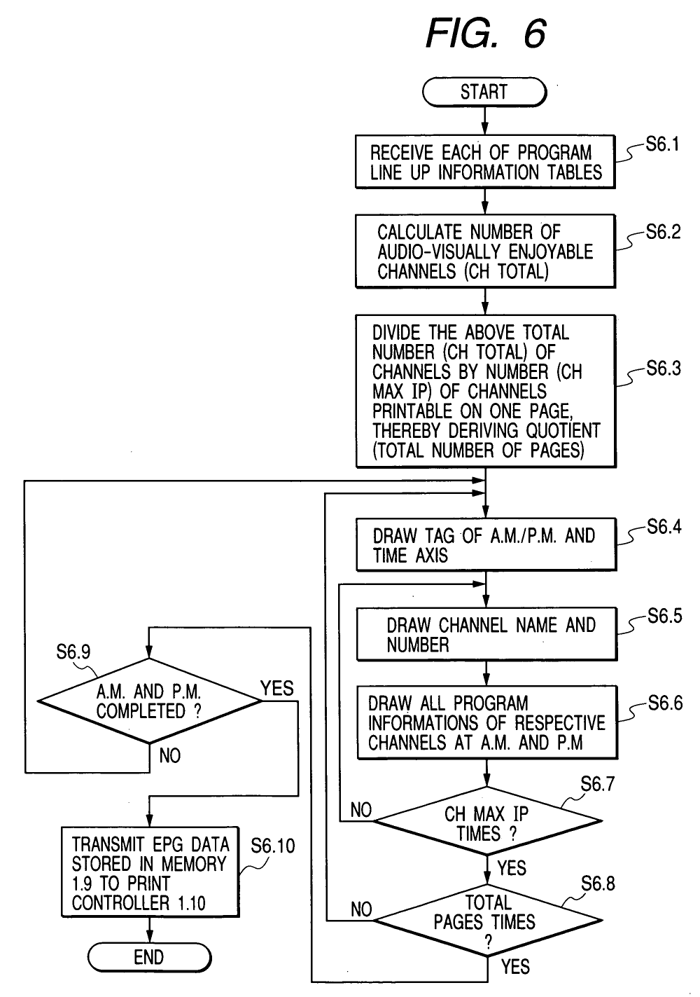

Finally, the system control unit 1.12 will be explained with reference to a flowchart in FIG. 6. The system control unit 1.12 receives each of program line-up information tables (see FIGS. 10A and 10B) from the demultiplex unit 1.3 (S6.1), and calculates the number of audio-visually enjoyable channels (which will hereinafter be abbreviated to CH_TOTAL) (S6.2). Then, the number of pages (which will hereinafter be referred to as PAGE) that should be printed is calculated by dividing CH_TOTAL by the number of channels printable on one page (which will hereinafter be abbreviated to CH_MAX_{—}1P) predetermined in consideration of a font size assumed to be easy-to-see to the viewers (S6.3).

As shown in FIG. 3, however, in the case of printing the program guide divided into the A.M programs and the P.M. programs, a value of PAGE is, as a matter of course, doubled. In the following discussion, a difference between the divided case into A.M and P.M. and an undivided case is easily presumed, and hence this discussion will be focused on only the case of printing the program guide divided into the A.M programs and the P.M. programs.

Processing of creating the program guide by use of the above-described drawing unit 1.8 and storing the program guide on the memory 1.9 similarly described above, will hereinafter be explained.

a) Draw A.M./P.M. tags and a time axis (a left end area in FIG. 3) (S6.4).

b) Draw channel numbers and channel names (an upper end area in FIG. 3) (S6.5).

c) Draw all pieces of A.M. or P.M. program information of each channel (S6.6).

d) Repeat back to the processing in b) till the processing is looped (CH_MAX_{—}1P)-times (S6.7).

e) Return to the processing in a) till the processing is looped PAGE-times (S6.8).

f) Return to the processing in a) till the creations of the program guide images of both of the A.M. programs and the P.M. programs are finished (S6.9).

g) The program guide image stored on the memory 1.9 is transmitted to the print controller 1.10 (S.10).

(Second Embodiment)

Successively, a second embodiment of the present invention will be discussed with reference to the drawings.

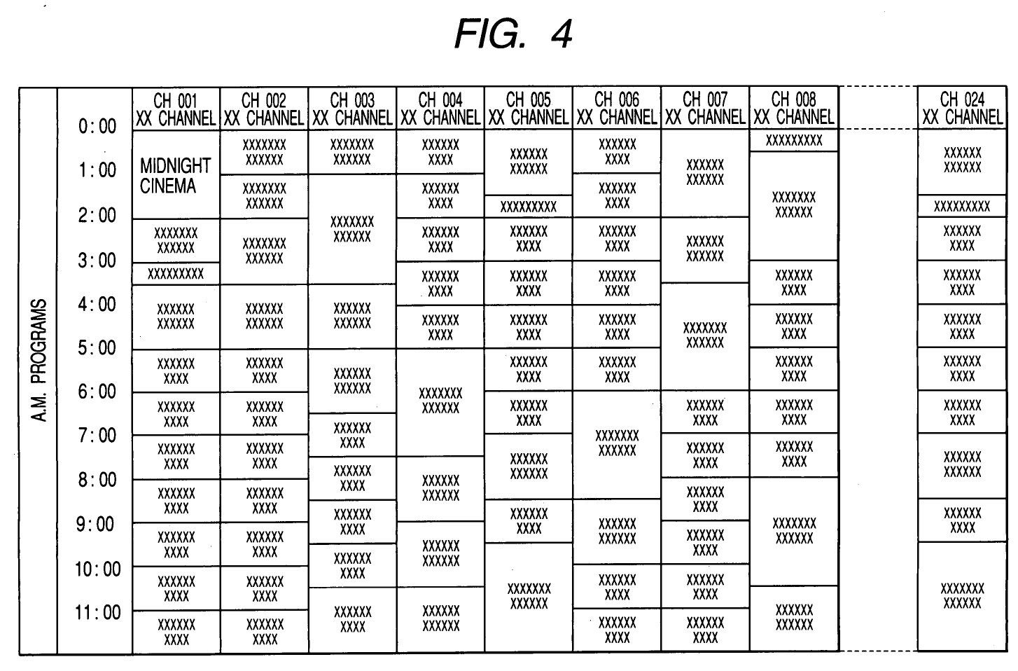

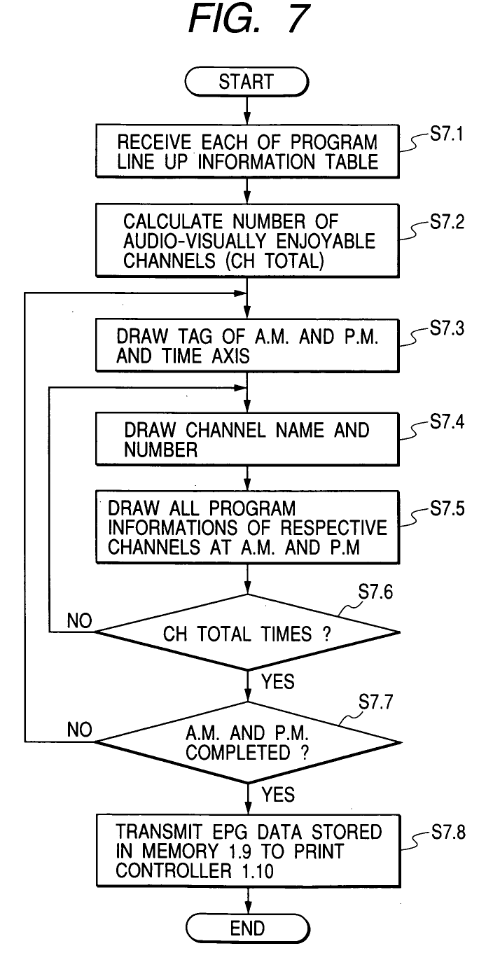

An example of the architecture of the television image receiver in the second embodiment of the present invention is the same as FIG. 1 illustrates in the first embodiment of the present invention, and therefore its explanation is omitted. Further, the second embodiment of the present invention has a difference only in the processing by the system control unit 1.12 in the architecture in FIG. 1, and hence this difference will be described referring to a conceptual diagram in FIG. 4 and a flowchart in FIG. 7.

The second embodiment of the present invention involves using the roll paper as a substitute for the fixed-size sheet utilized in the first embodiment. FIG. 4 shows an example of the program guide image in second embodiment of the present invention. The second embodiment of the present invention has no necessity of calculating the number of pages to be printed as the first embodiment of the present invention requires. The following is a detailed discussion referring to the flowchart in FIG. 7.

The system control unit 1.12 receives each of the program line-up information tables (see FIGS. 10A and 10B) from the demultiplex unit 1.3 described above (S7.1), and calculates the number of audio-visually enjoyable channels (which will hereinafter be abbreviated to CH_TOTAL) (S7.2). Herein, the audio-visually enjoyable channels include free-of-charge audio-visually enjoyable channels. As for the fee-charged channels, the program information on only the audio-visually enjoyable channels based on a user contract may be printed, or the program information on all the fee-charged channels may also be printed. In the case of including the audio-visually enjoyable channels based on the user contract, the number of audio-visually enjoyable channels is calculated with reference to the user's contract information retained on the TV receiver in addition to the aforementioned program line-up information.

Then, processing of creating the program guide in the predetermined font size assumed to be easy-to-see to the viewers by use of the drawing unit 1.8 described above and storing the created program guide on the memory 1.9 similarly described above, will be explained. As illustrated in FIG. 4, however, in the case of printing the program guide divided into the A.M. programs and the P.M. programs, the value of CH_TOTAL is, as a matter of course, doubled. In the following discussion, the difference between the divided case into A.M and P.M. and the undivided case is easily presumed, and hence this discussion will be focused on only the case of printing the program guide divided into the A.M programs and the P.M. programs.

a) Draw A.M./P.M. tags and a time axis (a left end area in FIG. 4) (S7.3).

b) Draw channel numbers and channel names (an upper end area in FIG. 4) (S7.4).

c) Draw all pieces of A.M. or P.M. program information of each channel (S7.5).

d) Repeat back to the processing in b) till the processing is looped (CH_TOTAL)-times (S7.6).

e) Return to the processing in a) till the creations of the program guide images of both of the A.M. programs and the P.M. programs are finished (S7.7).

f) The program guide image stored on the memory 1.9 is transmitted to the print controller 1.10 (S.7.8).

(Third Embodiment)

Successively, a third embodiment of the present invention will be discussed with reference to the drawings.

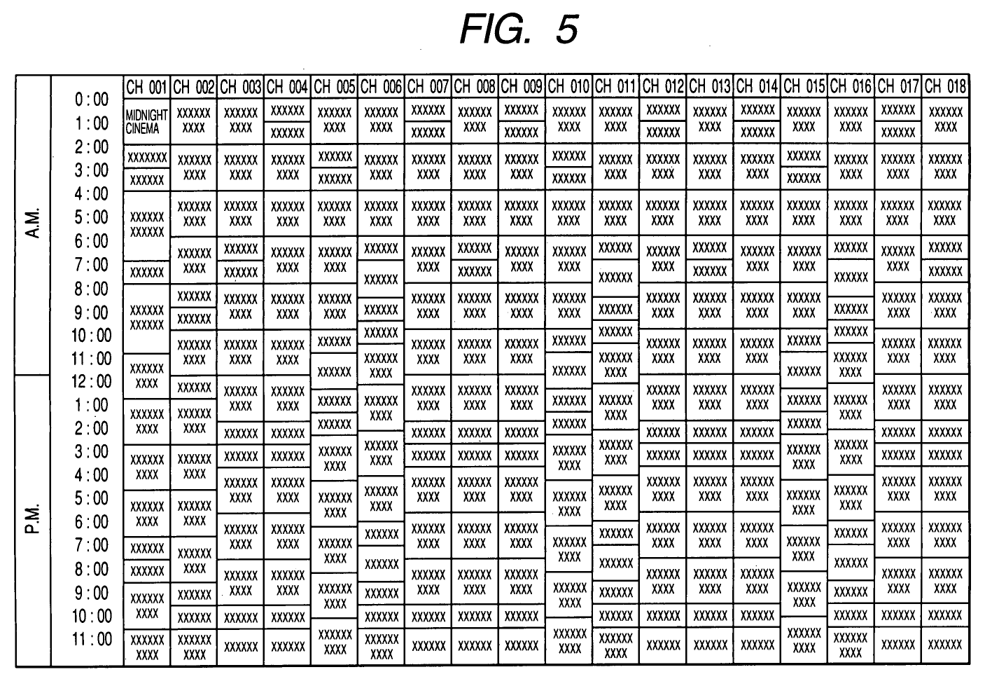

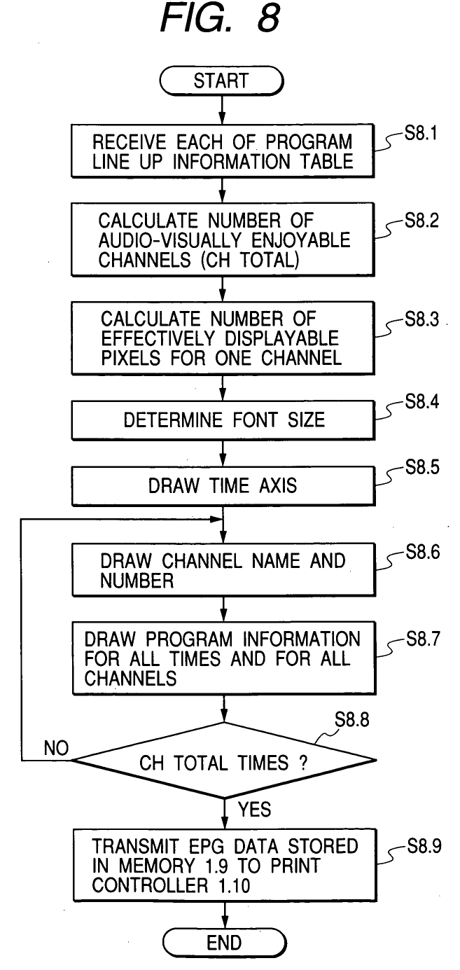

An example of the architecture of the television image receiver in the third embodiment of the present invention is the same as FIG. 1 illustrates in the first embodiment of the present invention, and therefore its explanation is omitted. Further, the third embodiment of the present invention has a difference only in the processing by the system control unit 1.12 in the architecture in FIG. 1, and hence this difference will be described referring to a conceptual diagram in FIG. 5 and a flowchart in FIG. 8.

In the third embodiment of the present invention, the font size is changed corresponding to the number of receivable channels so that the program guide information for 24 hours of all the audio-visually enjoyable channels can be printed on one page. FIG. 5 shows an example of the program guide image in the third embodiment of the present invention. In the third embodiment of the present invention, all pieces of information are aggregated on one page, and hence, if the operator is not a senior person, an advantage is that a necessary item of information is easy to detect and at the same time the sheets can be saved. The following is a detailed description referring to the flowchart in FIG. 8.

The system control unit 1.12 receives each of the program line-up information tables (see FIGS. 10A and 10B) from the demultiplex unit 1.3 described above (S8.1), and calculates the number of audio-visually enjoyable channels (which will hereinafter be abbreviated to CH_TOTAL) (S8.2). Then, the number of effectively displayable pixels (CH_WIDE) per channel and a font size are determined corresponding to the value of this CH_TOAL and to size information of a preset print sheet (S8.3, S8.4). The processing of creating the program guide by use of the drawing unit 1.8 described above and storing the created program guide on the memory 1.9 similarly described above, will hereinafter be explained.

a) Draw A.M./P.M. tags and a time axis (a left end area in FIG. 5) (S8.5).

b) Draw channel numbers and channel names (an upper end area in FIG. 5) (S8.6).

c) Draw all pieces of program information of each channel (S8.7).

d) Repeat back to the processing in b) till the processing is looped (CH_TOTAL)-times (S8.8).

e) The program guide image stored on the memory 1.9 is transmitted to the print controller 1.10 (S.8.9).

The case of printing the program information of all the audio-visually enjoyable channels on one page, has been discussed so far, however, as other modes, the program information may be printed on a set number of pages, the program information of designated channels may be printed, and the program information of programs acquired as a result of favorite search may also be printed on a predetermined number of pages.

(Fourth Embodiment)

Subsequently, a fourth embodiment of the present invention will be described with reference to the drawings.

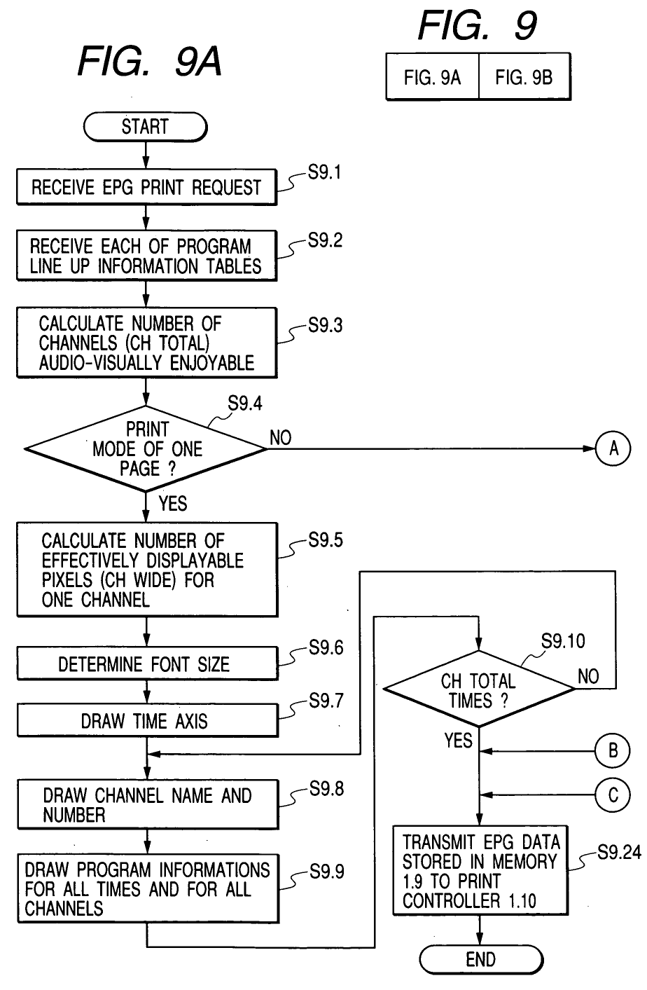

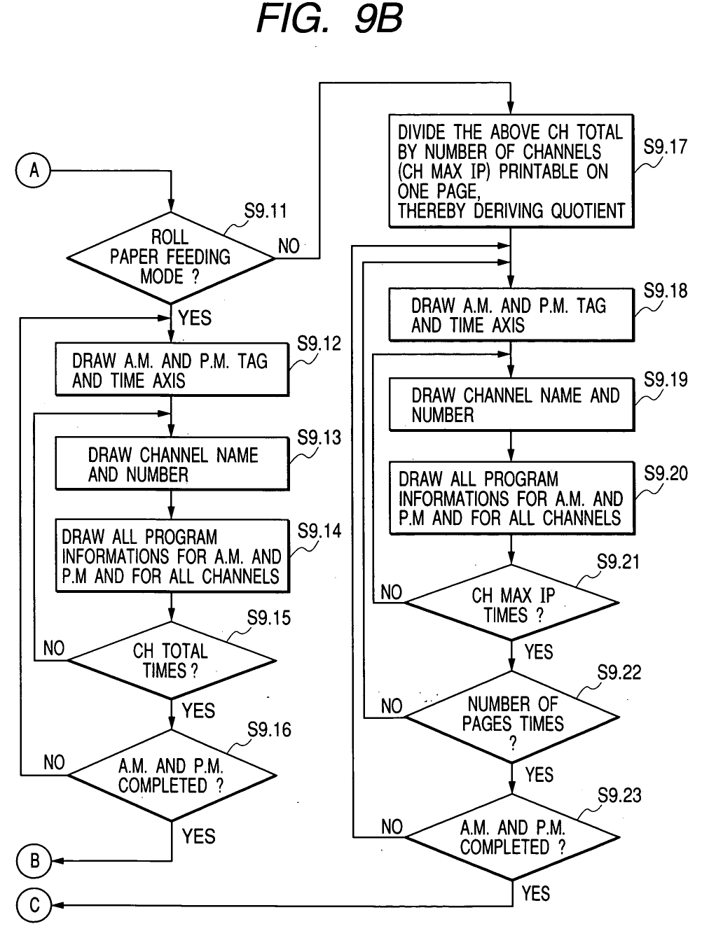

An example of the architecture of the television image receiver in the fourth embodiment of the present invention is the same as FIG. 1 illustrates in the first embodiment of the present invention, and therefore its explanation is omitted. Further, the fourth embodiment of the present invention has a difference only in the processing by the system control unit 1.12 in the architecture in FIG. 1, and hence this difference will be described referring to flowcharts in FIGS. 9A and 9B.

A contrivance in the fourth embodiment of the present invention is to enable the operator to select the printing modes in the first embodiment, the second embodiment and the third embodiment of the present invention. This contrivance makes the program guide information printable by a method that will be felt easy to see to the operator without depending on ages and favorites. Moreover, the embodiments of the present invention have illustratively dealt with the case of switching over the three printing methods given above, however, as a matter of course, the two methods among them may be selected, or a method(s) may be selected from among a larger number of methods to which other printing methods are added.

A detailed explanation will hereinafter be given referring to the flowcharts in FIGS. 9A and 9B. The system control unit 1.12, when accepting a program guide print request via the external input receiver 1.7 described above (S9.1), receives each of the program line-up information tables (see FIGS. 10A and 10B) from the demultiplex unit 1.3 explained above (S9.2), and calculates the number of audio-visually enjoyable channels (which will hereinafter be abbreviated to CH_TOTAL) (S9.3). Then, if the operator has selected the printing method (which will hereinafter be termed a 1-page print mode) according to the third embodiment, processing shown in each of the following items a) through f) is executed.

a) Calculate the number effectively displayable pixels (CH_WIDE) per channel in accordance with the value of CH_Total (S9.5).

b) Determine a font size in accordance with the value of CH_TOTAL (S9.6).

c) Draw A.M./P.M. tags and a time axis (S9.7).

d) Draw channel numbers and channel names (S9.8).

e) Draw all pieces of program information of each channel (S9.9).

f) Repeat back to the processing in d) till the processing is looped (CH_TOTAL)-times (S9.10).

If not so, when the operator has selected the printing method (which will hereinafter be termed a roll paper print mode) according to the second embodiment, processing shown in each of the following items g) through k) is executed.

g) Draw A.M./P.M. tags and a time axis (S9.12).

h) Draw channel numbers and channel names (S9.13).

i) Draw all pieces of program information of each channel (S9.14).

j) Repeat back to the processing in h) till the processing is looped (CH_TOTAL)-times (S9.15).

k) Return to the processing in g) till the creations of the program guide images of both of the A.M. programs and the P.M. programs are finished (S9.16).

If not so, when the operator has selected the printing method (which will hereinafter be termed a silver mode) according to the first embodiment, processing shown in each of the following items 1) through r) is executed.

l) The number of pages (PAGE) to be printed is calculated in a way that divides CH_TOTAL by the number of channels (CH_MAX_{—}1P) printable on one page (S9.17).

m) Draw A.M./P.M. tags and a time axis (S9.18).

n) Draw channel numbers and channel names (S9.19).

o) Draw all pieces of program information of A.M. or P.M. programs of each channel (S9.20).

p) Repeat back to the processing in n) till the processing is looped (CH_MAX_{—}1P)-times (S9.21).

q) Return to the processing in m) till the processing is looped (PAGE)-times (S9.22).

r) Return to the processing in m) till the creations of the program guide images of both of the A.M. programs and the P.M. programs are finished (S9.23).

Then, the program guide images created respectively in the 1-page print mode, the roll paper print mode and the silver mode and stored on the memory 1.9, are transmitted to the print controller 1.10 (S9.24).

According to the first through fourth embodiments of the present invention, it is possible to provide the television image receiver capable of simply promptly obtaining the want-to-get information from the program guide information printed in the easy-to-view form.

The present embodiment can be also actualized by a computer executing a program. Further, a means for supplying the computer with the program, for example, a readable-by-computer storage medium such as a CD-ROM, etc. stored with the program, or a transmission medium such as the Internet for transmitting such a program, can be also applied as an embodiment of the present invention. Moreover, a program product of the readable-by-computer storage medium, etc. stored with the above program can also be applied as an embodiment of the present invention. The category of the present invention embraces the aforementioned program, storage medium, transmission medium and program product. The storage medium can involve using, for instance, a flexible disk, a hard disk, an optical disk, a magneto-optic disk, a CD-ROM, a magnetic tape, a nonvolatile memory card, a ROM and so forth.

Note that any embodiments given above are nothing but the exemplifications in which the present invention is embodied, and the technical range of the present invention shall not be limitedly construed. Namely, the present invention can be embodied in a variety of forms without departing from the technical concept thereof or from the principal features thereof.

As discussed above, according to the present invention, the program information printed in the easy-to-view form can be obtained, whereby the want-to-get program information can be simply promptly acquired.

What is claimed is:

1. A television broadcast receiving apparatus comprising:
a receiving unit for receiving television broadcasting waves transmitted in a way that multiplexes program information data together with plural pieces of program data; and
a print controller for converting the program information data received by said receiving unit into data for printing, and outputting program information to a printer,
wherein said print controller determines a print mode of the program information so that the program information is laid out just on a predetermined number of page(s).

2. A television broadcast receiving apparatus according to claim 1, further comprising a selection unit for selecting a partial piece of program information data of the program information data,
wherein said print controller converts the program information data selected by said selection unit into data for printing, and outputs the data for printing to said printer.

3. A television broadcast receiving apparatus according to claim 2, wherein said selection unit respectively selects, from among the plural pieces of program information data, a piece of program information data on an audio-visually enjoyable program, a piece of program information data on a program that is broadcast for a predetermined broadcasting time zone, or a piece of program information data on a program searched out based on a predetermined condition in said television broadcast receiving apparatus.

4. A television broadcast receiving apparatus according to claim 1, wherein said print controller determines a font size for the program information in accordance with the number of programs contained in the program information data and with size information of paper used by said printer.

5. A television broadcast receiving apparatus according to claim 1, wherein said print controller determines a display width for each channel and a font size for the program information so that the program information is laid out just on a predetermined number of page(s) in a way that takes a time axis on one side of a fixed-size sheet and a channel axis of the channel, at which the program is broadcast, on the other side thereof.

6. A television broadcast receiving apparatus according to claim 5, wherein said print controller performs the control by selectively switching over a plurality of print modes.

7. A television broadcast receiving apparatus according to claim 6, wherein the plurality of print modes include a first print mode in which the display width for each channel and the font size for the program information are determined so that the program information is laid out just on one page, and a second print mode in which the display width for each channel and the font size for the program information are determined so as to print on a plurality of pages if the number of channels related to the program information is larger than a predetermined number of channels.

8. A television broadcast receiving apparatus according to claim 7, wherein the plurality of print modes further include a third print mode of controlling so as to print the program information on the fixed-size sheet in a fixed font size.

9. A television broadcast receiving apparatus according to claim 8, wherein the plurality of print modes further include a fourth print mode of controlling so as to print the program information on roll paper in a predetermined font size.

10. A television broadcast receiving method comprising:
a receiving step of receiving television broadcasting waves transmitted in a way that multiplexes program information data together with plural pieces of program data; and
a print control step of converting the received program information data into data for printing, and outputting program information to a printer,
wherein said print control step involves determining a print mode of the program information so that the program information is laid out just on a predetermined number of page(s).
